(19) United States
(12) Patent Application Publication
(10) Pub. No.: US 2017/0132859 A1
(43) Pub. Date: May 11, 2017

(54) Integrated Physical Access Control System

(71) Applicant: Rodney Troncoso, Pembroke Pines, FL (US)

(72) Inventor: Rodney Troncoso, Pembroke Pines, FL (US)

(21) Appl. No.: 14/935,415

(22) Filed: Nov. 8, 2015

(51) Int. Cl. G07C 9/00; H04L 29/08; H04L 12/10

(52) U.S. Cl. CPC G07C 9/00166; H04L 12/10; H04L 67/12

(57) ABSTRACT

A method is presented for a physical access control system which eliminates the major head end components including the immediate network switch, the access control enclosure, the access control expansion enclosure and the access control peripheral power supply. An access control computer with an embedded switch, said switch with 801.11af and 801.11at capabilities provides the only means of communications between the physical access control server and the access control field devices.

### FIELD OF THE INVENTION

The present invention is in the technical field of Physical Access Control Systems (PACS) and internet protocol (TCP/IP) based peripheral devices.

### BACKGROUND OF THE INVENTION

Physical access control systems today are very costly to deploy and require many components located in both in the central or head end of the system and also in the field that are required for its operation. But cost and system size are only a couple of the limiting factors that come into play when the purchase of an access control system is being considered by property managers and owners. Following then, is a description of this type of physical security system as it exists today.

The main components, which are housed in metallic enclosures, are referred to as controllers and these can vary in type based on their function and capabilities. They can be either main controllers, which store the system configuration data for their respective zones of control as well as user data such as credential information, or sub-controllers which perform various functions including locking and unlocking doors, receiving various inputs from field devices and interpreting and relaying card holder data read from badges, barcodes and transponders. Controllers are centrally located in order to maximize capacity and due to the enclosures they are enclosed in occupy large wall spaces in closets or telephone/data closets and also within ceiling spaces.

There are also controllers which expand the original system, referred to as expansion controllers that also fall under the category of main controllers or sub-controllers depending on the expansion requirements of the system. These requirements are based upon the needs of the secured facility or property, the capabilities and limitations of the controllers themselves and the access control management software. These expansion controllers are also housed in large metallic enclosures and also require wall and ceiling spaces.

In addition to the access control system components listed above, these systems also require power supplies that power not only the actuation of the door locks and providing power for the field devices of an access control system but also provide the power for the controllers as well. These power supplies are housed in their own separate enclosures and are mounted either at the head end or in another centralized location or above ceilings spaces.

The space requirements for the above equipment is very often at odds with the space availability of the facility or property being secured making their successful installation a matter of priority first or on a first come first serve basis. The deployment of a physical access control system, with the many different components listed above, requires hundreds of square feet of wall and ceiling space; space which is highly limited and often disputed for by existing trades that are involved during the installation of a building's technical infrastructure; trades such as telephone, cable and internet. Therefore space becomes a limiting factor to a successfully installed access control system.

The different components and the respective enclosures listed above all require dedicated power circuits with their own circuit breakers to be installed. The installation of high voltage circuitry can only be done by licensed professionals and this adds to the cost of ownership of an access control system.

Another limiting component of the physical access control system is the bundles of specialized multi-conductor cabling. This type of cabling is singular in purpose but is required to support a typical access control system. This cabling is more expensive to install as it is generally done under contract by specialized labor. It also costs more per foot than category 5 or 6 cabling that is already used by Information Technology or IT departments. Therefore this is a factor which adds to the cost of ownership of an access control system.

Trades which specialize in physical access control system installations, also known as system integrators, are the principal installation professionals of an access control system. During the deployment of a physical access control system, tens, hundreds and sometimes thousands of labor hours by system integrators, and not to mention high voltage and Information Technology (IT) professionals, are required; bundled together as well with the personnel management resources that are required to run and manage these types of installations, the cost of labor required to support an access control system deployment quickly mounts into the tens of thousands of dollars. Additionally, as the typical access control system expands these initial resources tend to be duplicated, in essence fractionally repeating the initial expenditure of the original deployment. This also adds to the cost of an access control system.

Traditional multi-door controllers can be expensive, ranging anywhere from $800 for a two door controller to over $3,500 for an 8-door controller. When added to the cost of the main controller, between $1300 and $2000 as well as the cost for installing all the proprietary access control cable end-user costs in most situations range between $2,000 and $3,500 per door.

Therefore the cost, material and space factors listed above, while necessary for the functionality of an access control system, are all limiting factors that must be considered by the property managers and owners but also mostly restricts its use and benefits to larger commercial industries such as manufacturing, hospitals, utility companies, institutes of higher learning and government. They exclude then, for the most part, the use and ownership of these systems, the smaller industries such as private offices or businesses, residential and residential-commercial sectors.

Because organizations of all shapes and sizes today invest and rely heavily on Information Technology networks or IT to manage business processes it should follow that physical access control systems should better leverage these IT investments as much as possible, using the same infrastructure and philosophy as the rest of the enterprise. However, this has not been the case. Although the physical security system industry as a whole has made strides in this very direction with closed circuit television and intrusion detection systems using the IT infrastructure, the access control system design around IT has lagged behind.

### SUMMARY OF THE INVENTION

The following configuration of the invention is only the preferred configuration and is not intended to be limiting.

The present invention disclosed relates to a new compact configuration design for a physical access control system which automatically powers, detects, identifies, configures and monitors access points via a series of IP Reader Controller or IP Readers or IP door controllers connected input/output devices reducing or eliminating the limiting factors mentioned above that are required for the operation of a physical access control system.

Accordingly the system is comprised of a set of networked IP Reader Controller or IP Readers and/or IP door controllers, low power consumption electrified locking hardware such as door strikes and electro-magnetic locks, door position sensors and request to exit devices, a network access control computer, a PC client workstation. The IP Reader Controller or IP Readers are connected directly to the network access control computer, which is also known as an access control server, without the addition of an external Ethernet switch. The PC web client is connected to the network access control computer through the network access control computer server uplink port and is reachable via a standard TCP/IP network.

The network access control computer is comprised of a motherboard with a microprocessor, memory, a hard drive and a bank of power over Power over Ethernet (POE) enabled interface ports. The numbers of network access control computer interface ports can be configured to contain 4, 8 and 16 ports or more and the number of ports is determined by the security needs of the facility and the network access control computer's on board POE enabled switch.

The access control management server has an embedded managed network interface switch which can be configured with 4, 8 or 16 ports or more and through the network security management software are capable of recognizing measures to defeat the network security of the access control system by detecting an attempt to remove an IP Reader Controller or IP Readers and shutting down the compromised port or ports.

The access control management computer is comprised of a processor module, a heat sink and a carrier board. The processor module includes a microprocessor connected to memory and will be connected as well to a BIOS flash, a group of 10/100 Base-T RJ-45 ports for POE connections and one or more 10/100/1000 Base-T RJ-45 ports for uplink connection to other computers or networks. The carrier board further includes one VGA video port, one HDMI video port, one or more SATA ports and one or more USB ports. Additionally the carrier board includes a storage drive.

In an alternate configuration the network access control computer's carrier board will have memory slot for the insertion of a miniature memory module that will safely provide a means of backing up the complete configuration parameters of the physical access control system.

The access control software and operating system is stored on the solid state storage drive.

The access control computer supports all network compliant IP Reader Controller or IP Readers, IP door controller and IP input/output controllers connected to the access control computer through the PoE RJ-45 ports. Once connected all devices are automatically powered, assigned an IP address and ready to be configured for the site via the access control management software stored on the storage drive of the computer.

The access control computer via the OS features Internet Information Services or IIS support web services by which the PC clients can connect to, monitor, change and control system parameters and the IP devices connected to the access control computer.

The access control database is stored and maintained on the access control computer and can be managed by direct connection with a monitor keyboard and mouse to the access control computer or via the PC client. While in production, the access control computer receives user instruction via the PC client web interface by which the user builds the site configuration and modifies, monitors and controls the access control doors of the site as well as maintains via user input on the PC client station the user information for the site.

In multi-site access control system requirements, remote IP Reader Controller or IP Readers and IP door controllers connected to a network via standard PoE switches are routed to the access control computer by way of IP routing and therefore offsite security can be managed remotely.

The access control computer in combination with the client pc supports live monitoring, door controls, transactional history reporting and auto-unlock scheduling of doors.

### BRIEF DESCRIPTION OF THE DRAWINGS

FIG. 1 is a diagram showing the LAN based network of access control devices managed directly by a network access control computer and IP client PC.

FIG. 2 is a diagram showing a LAN based network including an access control computer managed remotely by a client PC.

FIG. 3 is a diagram showing the access control system with a wireless interface enabling a communications with a smart device.

FIG. 4 is a graphic view of the rear panel of the access control computer allowing connections from the IP Reader Controller or IP Readers and connected door devices.

FIG. 5 is a diagram showing the LAN based network of IP Reader Controller or IP Readers connected to a secondary network of IP Reader Controller or IP Readers managed by multiple PC clients.

FIG. 6 is a diagram showing the LAN based network of access control devices managed directly by the access control management computer with the addition of a secondary LAN based group of access control devices connected to a secondary PoE network switch and managed remotely by a network access control computer.

### DETAILED DESCRIPTION OF THE INVENTION

Disclosed herein is a physical access control system configuration that automatically powers a series of IP Reader Controller or IP Readers and access control door hardware via directly connecting to the access control server computer. Installation of access control power supplies, main controllers, sub controllers and expansion controllers is no longer required; also no longer required are the enclosures in which these are housed. Installation of network switches used to interconnect the IP Reader Controller or IP Readers to the access control server is not required.

The access control system design is comprised of an access control server, an access control client workstation, an IP Reader Controller or IP Readers or a group of IP Reader Controller or IP Readers, a request to exit device or group of request to exit devices, door sensors and electrified locking door hardware, the access control server computer itself has an integrated Ethernet POE network switch which will eliminate the need for external network switching devices and access control power supplies.

The physical access control computer is comprised of a microprocessor, memory, BIOS, a hard drive and multiple power over Ethernet or POE enabled interface ports. The number of ports can be and is preferable in configurations of 4, 8, 16 ports or more.

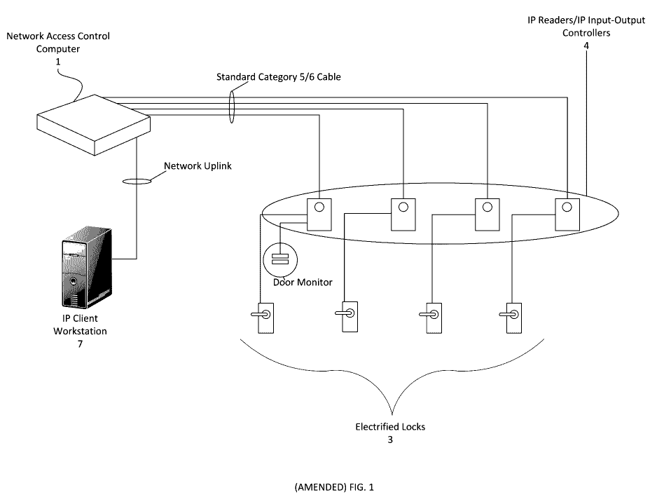

In FIG. 1 the access control computer which has an integrated Ethernet POE switch will connect directly to IP Reader Controller or IP Readers using only category 5 or 6 cabling and will provide the necessary power requirements for the reader and door control and monitoring components such as the request to exit motion sensing device and the electrified door hardware. The components of the controlled door such as the IP Reader Controller or IP Readers, the electrified locking hardware, the door position sensors and the request to exit motion sensors are powered exclusively by the embedded Ethernet POE switch within the access control computer.

The access control system server includes an access control management software which manages and monitors the IP Reader Controller or IP Readers and the doors which connect to them.

The operating system and access control management software is stored on the harddrive.

The access control system here described is different from a typical access control system in that it does not require the use of an external power supply housed within metal enclosures since the embedded POE switch within the access control server will provide the necessary power requirements to the IP Reader Controller or IP Readers and the adjoining door control and monitoring devices. Further it will not require any external main controllers or sub controllers housed within metal enclosures as it will solely use IP Reader Controller or IP Readers which provide the configuration information for reading card holder credentials and unlocking doors.

As designed this system automatically provides the necessary power, security system communications and access monitoring that a typical access control system provides without the typical consumption of labor, space and material costs.

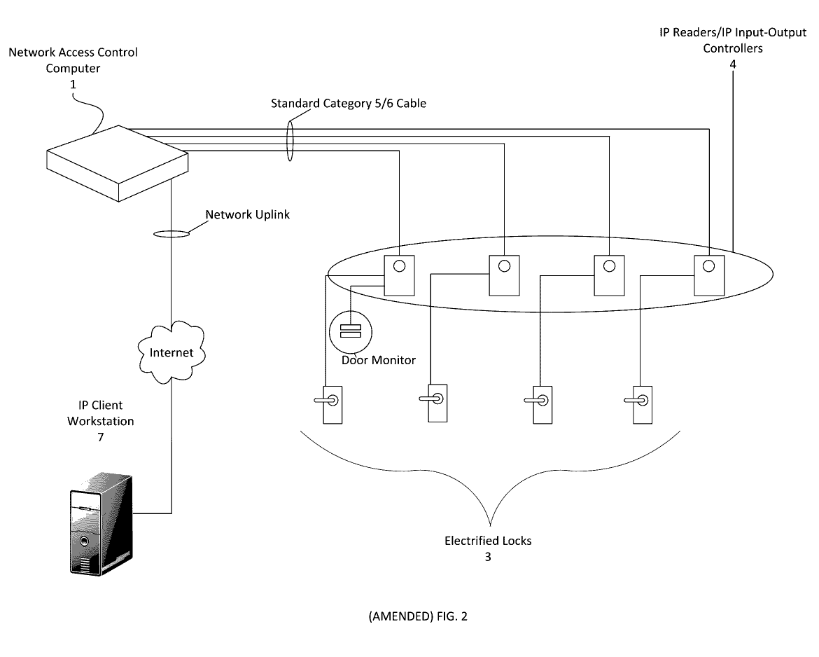

In FIG. 2 the access control computer is managed remotely by an IP client computer remotely.

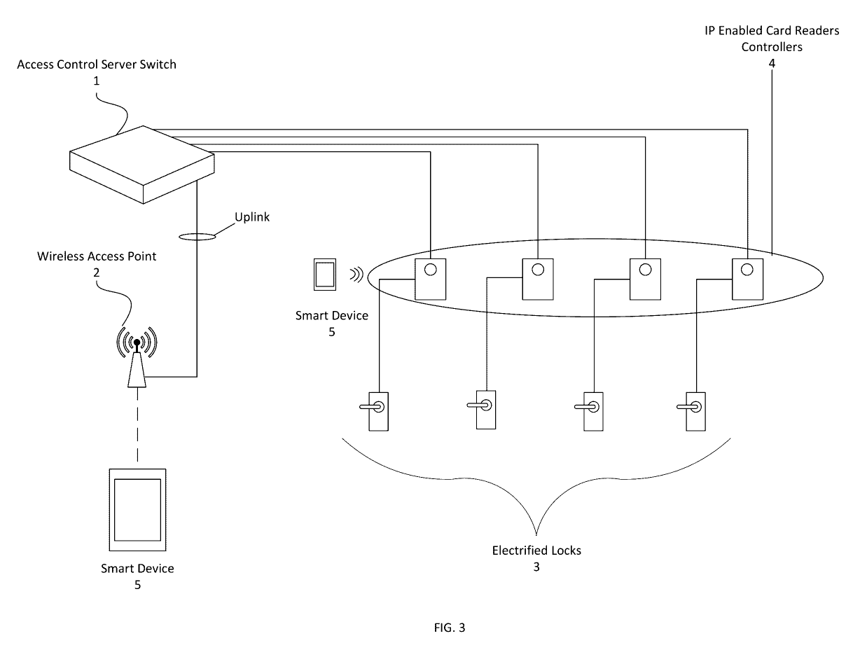

In FIG. 3 the access control computer is connected to a wireless access point by which any WIFI enabled device including smart phones, wireless laptops can connect to the access control computer to control doors, receive system alarms, add users and cards, monitor access points check system integrity and lock the access control doors.

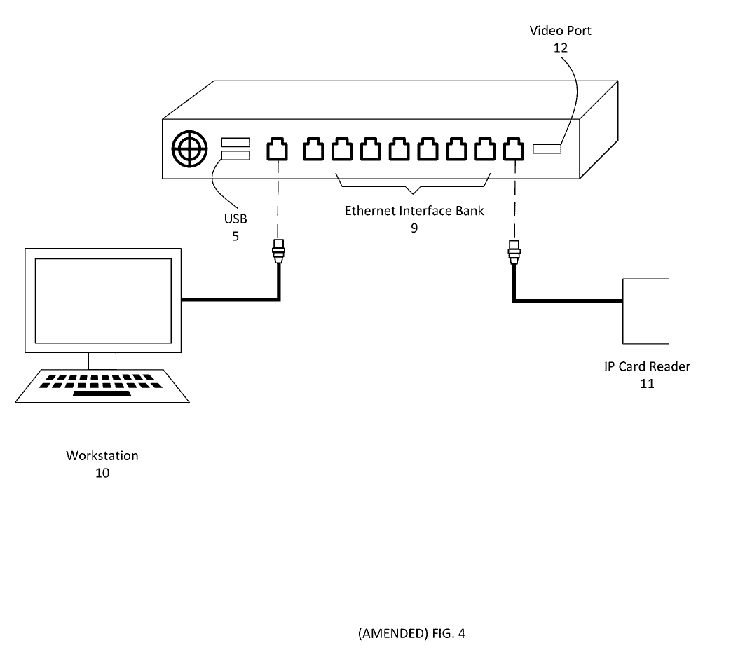

In FIG. 4 the access control server back panel is shown with USB ports for keyboard and mouse connections, an uplink port for network connections, a bank of Power over Ethernet ports for connection of IP Reader Controller or IP Readers and IP input and output modules and a video port for connection of a viewing monitor.

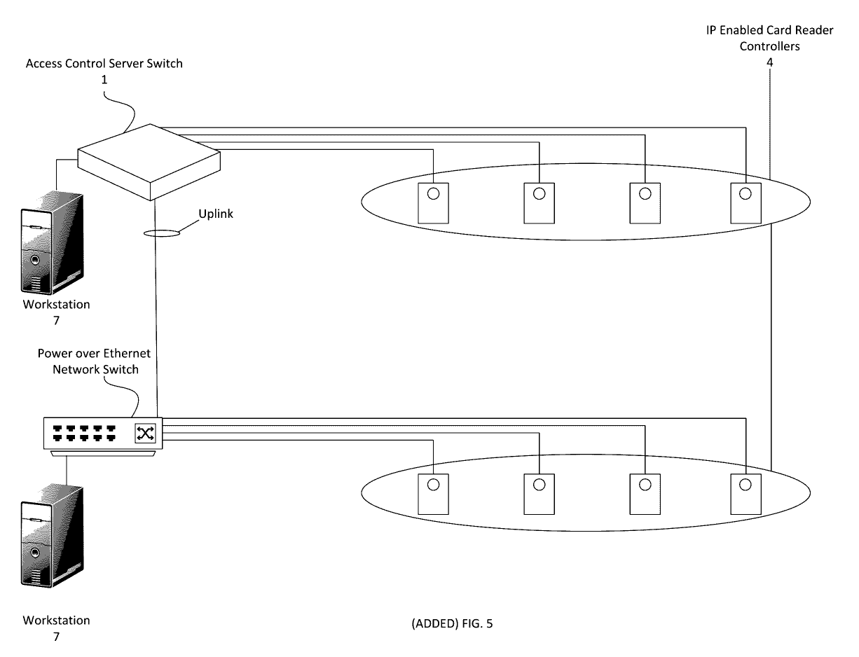

In FIG. 5 the access control computer is shown as a server switch connected to a PC client workstation. Via the access control uplink port a secondary LAN is connected comprising a PoE switch, a secondary PC access control management client and IP Reader Controller or IP Readers for the purpose of expansion of the security system without the need of access controllers, access control power supplies, controller enclosures or power supply enclosures.

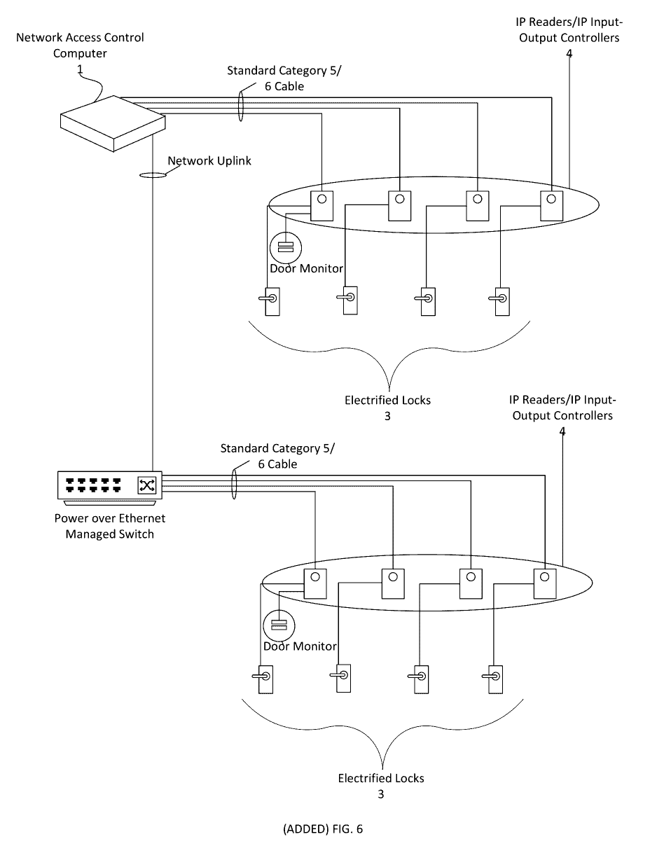

In FIG. 6 the access control computer is shown as a LAN comprising a server switch connected to IP Reader Controller or IP Readers and via the uplink port will connect to an additional and secondary LAN of IP Reader Controller or IP Readers which are managed remotely by direct connection to the access control server computer.

The access control computer will automatically power the connected access control devices. IP Reader Controller or IP Readers and IP input and output modules will connect to the access control computer using standard category 5 or category 6 cabling. This eliminates the requirement of using specialized structured cabling for an access control installation.

The access control computer can be mounted in a standard IT rack or on a shelf or desktop. The requirement of having wall space on which to mount access control and power supply enclosures therefore is no longer necessary.

During deployment of the access control system the access control computer is mounted in a 1U rack space. Network cabling is run to the predetermined access control doors or physically monitored points where will be installed IP Reader Controller or IP Readers controller and/or IP input and output modules. The electronic door lock, the request to exit device, the door position monitor and the card reader are connected to the IP Reader Controller or IP Readers controller. The power for these devices is provided by the access control computer embedded Power over Ethernet switch. Once the access control computer is provided with power, the POE switch in turn provides power to the IP Reader Controller or IP Reader and connected peripherals.

The access control IP Reader Controller or IP Reader is connected to the access control computer until the available Power over Ethernet ports are all in use. Once all ports are used the expansion of the system and the addition of IP readers is accomplished by adding a secondary Power over Ethernet switch. This step can be repeated throughout the life of the access control system in order to satisfy the security needs of the facility.

Management of the access control system is accomplished via a PC client that is connected to the network via IP routing. The PC client will navigate to the access control computer which serves as a web server. The user will open the access control management webpage, provide a user name and password and from there proceed to configure the site parameters, enable the access control readers to begin monitoring and controlling the access control points and downloading the cardholder and user database to the IP reader controller or IP readers.

Although the present embodiment has been described herein those skilled in the art should understand that various changes, alterations and substitutions may be made without departing from the spirit and scope of the present disclosure. The size of the access control computer and the number of ports may be scaled but any such changes, alterations or substitutions are intended to be included within the scope of the present disclosure as defined in the following claims, mean-plus-function clauses are intended to cover the configurations described herein as improving the common access control system design and not only structural equivalents but equivalent structures.

1. A physical access control system comprising:
a network access control system method that uses a first computer with an embedded Power over Ethernet switch;
a group of security IP Reader Controllers or IP Readers attached to the Power over Ethernet ports of the first computer using standard category 5 or category 6 cabling;
a group of IP readers which grouped comprise a full access control system that connect directly to the access control computer;
an IP client computer, a display, memory and a storage device connected to the access control system computer via a second network.

2. A method for implementing a security system comprised of a set of IP-enabled reader devices connected by an Ethernet network to a set of Ethernet ports on an access control computer having a set of local Ethernet Ports and a processor, the access control computer including a memory and storage device also connected to the processor, the method comprising the following steps:
serving a web session from the access control computer to the access control IP client workstation;
the access control computer searching the network for IP readers connected to the local Ethernet ports;
the Ethernet controllers receiving device data from the IP readers or IP reader controllers or IP Input and Output modules connected to the set of local Ethernet ports;
the access control computer storing receiving event transaction data from the IP security devices;
the access control computer storing the set of event transactions in the access control computer database.

3. The method of claim 2 including step of the Ethernet controllers controlling power to the IP reader controllers, the IP reader or IP Input and Output modules by supplying power to each IP enabled security device through the local Ethernet ports over a set of PoE Ethernet cables in the Ethernet Network.
